(19) United States
(12) Patent Application Publication
(10) Pub. No.: US 2014/0280304 A1
(43) Pub. Date: Sep. 18, 2014

(54) MATCHING VERSIONS OF A KNOWN SONG TO AN UNKNOWN SONG

(71) Applicants: Steven D. Scherf, Fremont, CA (US); Markus K. Cremer, Orinda, CA (US); Bob Coover, Orinda, CA (US)

(72) Inventors: Steven D. Scherf, Fremont, CA (US); Markus K. Cremer, Orinda, CA (US); Bob Coover, Orinda, CA (US)

(21) Appl. No.: 13/838,810

(22) Filed: Mar. 15, 2013

(51) Int. Cl. G06F 17/30

(52) U.S. Cl. CPC G06F 17/30026
USPC 707/769

(57) ABSTRACT

Methods and systems for determining a certain version of a known media content item, such as an known audio recording, matches an unknown media content item, such as an unknown audio recording, are described. In some example embodiments, the methods and systems facilitate the identification of a media content item as a specific version of a song or other audio recording by performing comparisons of the differences between two or more versions of the song or audio recording, among other things.

### TECHNICAL FIELD

The subject matter disclosed herein generally relates to the processing of data. Specifically, the present disclosure addresses systems and methods to matching an unknown media content item to a correct version of a media content item.

### BACKGROUND

Often, a person may encounter an unknown song or recording, and want to know the name, or other information, of the recording, as well as obtain a digital copy of the recording. In addition, a person may wish to obtain a digital copy of a recording already owned by the person in another format, such as a CD or other digital file format, or build an online library of songs and other recordings that is based on songs already owned by the person.

Typically, a system may identify an unknown audio recording or video clip (e.g., a recording or clip unknown to a user and/or to the system) by determining a fingerprint for the recording or clip, and comparing the fingerprint to a collection of reference fingerprints that are associated with known recordings or clips. Once a match is found, the system may determine that the unknown recording or clip is the known recording or clip associated with the matching fingerprint.

### BRIEF DESCRIPTION OF THE DRAWINGS

Some embodiments are illustrated by way of example and not limitation in the figures of the accompanying drawings.

FIG. 1 is a network diagram illustrating a network environment suitable for identifying unknown media content items, according to some example embodiments.

FIG. 2 is a block diagram illustrating components of a song identification system, according to some example embodiments.

FIG. 3A is a flow diagram illustrating an example method for identifying a correct version of a media content item, according to some example embodiments.

FIG. 3B is a flow diagram illustrating an example method for matching a query fingerprint to a reference fingerprint, according to some example embodiments.

FIG. 4 is a flow diagram illustrating an example method for identifying a correct version of a known media content item based on bit error rate calculations, according to some example embodiments.

FIG. 5 is a flow diagram illustrating an example method for identifying a correct version of a known media content item based on a difference map between versions of the known media content item, according to some example embodiments.

FIG. 6 is a flow diagram illustrating an example method for identifying a correct version of a known media content item based on a comparison of vocal tracks, according to some example embodiments.

FIG. 7 is a flow diagram illustrating an example method for comparing an unknown media content item to two or more versions of a known media content item according to some example embodiments.

FIG. 8 is a block diagram illustrating components of a machine, according to some example embodiments, able to read instructions from a machine-readable medium and perform any one or more of the methodologies discussed herein.

### DETAILED DESCRIPTION

### Overview

Example methods and systems for determining a certain version of a known media content item, such as a song or other audio content item, matches an unknown media content item are described. In some example embodiments, the methods and systems facilitate the identification of a media content item as a specific version of a song or other audio recording by performing comparisons of the differences between two or more versions of a song or audio recording, among other things.

For example, the methods and systems may query, using at least one query fingerprint, a database of reference fingerprints associated with a plurality of known media content items, at least one query fingerprint being derived from an unknown media content item, determine that a result of the query identifies two or more versions of a known media content item of the plurality of known media content items. The systems and methods may identify a portion of the known media content item where a first reference fingerprint associated with a first version of the known media content item differs from a second reference fingerprint associated with a second version of the known media content item. The systems and methods may match at least one query fingerprint to a subset of the first reference fingerprint and a subset of the second reference fingerprint associated with the portion of the known media content item that differs between the first reference fingerprint and the second reference fingerprint, and identify the unknown media content item based on a match between the at least one query fingerprint and one of the first reference fingerprint and the second reference fingerprint.

In some example embodiments, the methods and systems may compare a query fingerprint to reference fingerprints representing multiple versions of a known media content item, and determine one of the versions of the known audio media content item match the unknown media content item based on a quality of the comparison.

In some example embodiments, the systems and methods described herein enable a song identification system to match a specific version (e.g., a clean or explicit version) of a song or other digital media item to an unknown song or digital media item, among other things. Such identification of specific versions of songs and other digital media items using fingerprint matching techniques enables users to build music and other multimedia libraries that include the correct versions of their songs and other multimedia, among other things.

In the following description, for purposes of explanation, numerous specific details are set forth to provide a thorough understanding of example embodiments. It will be evident to one skilled in the art, however, that the present subject matter may be practiced without these specific details.

### Example Network Environment

FIG. 1 is a network diagram illustrating a network environment 100 suitable for identifying unknown media content items, according to some example embodiments. For example, a media content item may include a digital media item, such as an audio media item (e.g., a song or other audio recording), a video media item (e.g., a television show, movie, or other video clip), a video game, and so on. The network environment 100 may include a reference library or reference server 110, which includes a reference fingerprint generator 115 that determines and/or calculates reference fingerprints of known media content items, such as audio recordings stored or accessible by the reference library 110. The reference library 110 may include and/or access a reference fingerprint database 117 that includes an index or other data structure that indexes information associated with known media content items, such as reference fingerprint information for the known media content items.

One or more client devices 120 may access and/or receive an unknown media content item and communicate with the reference library 110 over a network 130, in order to perform a search or otherwise query the reference library to identify the unknown media content item. The client devices 120 may include a query fingerprint generator 125 that determines and/or calculates query fingerprints of unknown media content items, such as accessed and/or received media content items.

The client devices 120 may include laptops and other personal computers, tablets and other mobile devices, gaming devices, and other devices capable of accessing media content items and performing queries of databases of multimedia content over the network 130. The network 130 may be any network that enables communication between devices, such as a wired network, a wireless network (e.g., a mobile network), and so on.

Audio and video fingerprint algorithms and other methods used to compare, match, and/or identify unknown media content items, such as songs and other audio recordings, are generally configured to optimize their robustness, time alignment, and/or fingerprint size, among other things. For example, the size of an audio fingerprint may become secondary to the robustness of the matching technique when a user is trying to identify a single song recorded live from a cell phone, whereas robustness may be minimized when a method is used to ascertain whether a user's audio recording (e.g., on client device 120) matches known authorized examples of the same songs in a larger authorized database (e.g., reference library 110). In such cases, the system may derive a fingerprint for an entire length of each song to be matched, using large amounts of bandwidth to perform a database query.

In some example embodiments, an audio fingerprint may represent a short summary of an audio object or audio content item, such as a song. Therefore, an audio fingerprint, such as a query fingerprint or reference fingerprint, maps an audio content item, that has a large number of bits, with a small, limited number of bits. For example, generated fingerprints may be represented in a variety of ways, such as vectors of real numbers, bit-strings, and so on.

In some cases, the query fingerprint generator 125 and/or the reference fingerprint generator 115 may generate fingerprints for media content items such that similar fingerprints are generated for perceptually similar media content items, such as two similar versions (e.g., a clean and an explicit version) of the same media content item.

As described herein, the query fingerprint generator 125 and/or the reference fingerprint generator 115 may consider various factors when generating fingerprints in order to match a query fingerprint representing an unknown media content item to a reference fingerprint representing a known media content item. Example factors include:

The robustness of the fingerprint, where a fingerprint is based on perceptual features that are invariant (at least to a certain degree) with respect to signal degradations (e.g., severely degraded audio still leads to very similar fingerprints), leading to low false negative rates;

The reliability of the fingerprint, where a fingerprint has a high or low false positive rate;

The size of the fingerprint, usually expressed in bits per second or bits per song, that determines the memory resources that are needed for fingerprint comparison methods;

The granularity of the fingerprint, which is associated with how many seconds of content is needed to identify media content item, and may be application dependent; and/or

The search speed and scalability of a fingerprint comparison.

Thus, the query fingerprint generator 125 and/or the reference fingerprint generator 115 may be configured to determine fingerprints for media content items based on various combinations of the various factors, depending on the needs of the system and/or application.

In some example embodiments, in order to generate, determine, and/or calculate a fingerprint, the query fingerprint generator 125 and/or the reference fingerprint generator 115 accesses a digital signal of a media content item, segments the media content item into frames, and computes a set of features for each frame. The fingerprint generators 125, 115 may select features that are generally invariant to signal degradations, such as Fourier coefficients, Mel Frequency Cepstral Coefficients (MFFC), spectral flatness, sharpness, Linear Predictive Coding (LPC) coefficients, derivatives, means and variances of audio features, and so on. The generators 125, 115 may map the extracted features into a more compact representation (e.g. a sub-fingerprint) by using classification algorithms, such as Hidden Markov Models, or quantization. Thus, the fingerprint generators 125, 115 may convert a media content item to a fingerprint as a group of sub-fingerprints, where any portion sub-fingerprints that may be used to identify the media content item is a sub-fingerprint block.

For example, the fingerprint generators 125, 115 may extract 32-bit sub-fingerprints for every interval of 11.6 milliseconds of audio recording, where a fingerprint block includes 256 subsequent sub-fingerprints, corresponding to a granularity of 3 seconds. For example, the audio recording is first segmented into overlapping frames having a length of 0.37 seconds and weighted by a Hanning window with an overlap factor of 31/32, resulting in the extraction of one sub-fingerprint for every 11.6 milliseconds.

Generally, advantageous, perceptual, audio features reside in the frequency domain of an audio recording. Therefore, a fingerprint generator 125 or 115 may compute a spectral representation by performing a Fourier transform on every frame, wherein, in some cases, retaining only the absolute value of the spectrum (e.g., the power spectral density). In order to extract a 32-bit sub-fingerprint value for every frame, the fingerprint generator 125 or 115 selects 33 frequency bands, which lie between 300 Hz to 2000 Hz, and often have a logarithmic spacing.

In some example embodiments, a song identification system 140 communicates with the reference library 110 and the client device 120 over the network 130 in order to assist in the identification of an unknown media content item, such as an unknown song having multiple versions (e.g., a clean and explicit version).

For example, the song identification system 140 query the reference fingerprint database 117 with a query fingerprint derived from a media content item in order to match the query fingerprint to one or more reference fingerprints, and obtain a query result that identifies multiple matching reference fingerprints, including reference fingerprints that represent two, different versions of the media content item. The song identification system 140 may perform various methods in order to match the query fingerprint to the reference fingerprint representing the correct version of the media content item.

In some example embodiments, the song identification system 140 may include modules and other components configured to perform methods that identify one or more differences between two or more versions of a media content item, and utilize the differences when matching a query fingerprint representing an unknown media content item to a reference fingerprint representing the correct version of a known media content item.

In some example embodiments, the song identification system 140 may include modules and other components configured to perform methods that compare a query fingerprint to all reference fingerprints associated with versions of a media content item, and determine the correct version of the known media content item based on various matching criteria (e.g., a calculated match score) assigned to the comparisons.

Any of the machines, databases, or devices shown in FIG. 1 may be implemented in a general-purpose computer modified (e.g., configured or programmed) by software to be a special-purpose computer to perform the functions described herein for that machine. For example, a computer system able to implement any one or more of the methodologies described herein is discussed below with respect to FIG. 8. As used herein, a “database” is a data storage resource and may store data structured as a text file, a table, a spreadsheet, a relational database, a triple store, or any suitable combination thereof. Moreover, any two or more of the machines illustrated in FIG. 1 may be combined into a single machine, and the functions described herein for any single machine may be subdivided among multiple machines.

Furthermore, any of the modules, systems, and/or generators may be located at any of the machines, databases, or devices shown in the FIG. 1. For example, aspects of the song identification system 140 may reside at the reference library 110, the client device 120, or at both locations. For example, the song identification system 140 may include components at the client device 120 configured to pre-process query fingerprints before comparison, and likewise may include components at the reference library 110 configured to pre-process reference fingerprints before comparison, among other configurations.

### Examples of Identifying a Correct Version of an Unknown Media Content Item

As described herein, the song identification system 140 facilitates the identification of a media content item as a specific version of a media content item (e.g., a song or audio recording) by performing comparisons of the differences between versions of a known media content item, among other things. FIG. 2 is a block diagram illustrating components of the song identification system 140, according to some example embodiments. As shown in FIG. 2, the song identification system 140 includes a query module 210, a difference comparison module 220, and a match module 230.

One or more of the modules described herein may be implemented using hardware (e.g., a processor of a machine) or a combination of hardware and software. Moreover, any two or more of these modules may be combined into a single module, and the functions described herein for a single module may be subdivided among multiple modules.

In some example embodiments, the query module 210 is configured and/or programmed to query a database of reference fingerprints (e.g., reference fingerprint database 117) associated with known media content items with a query fingerprint derived from an unknown media content item, and determine that a result of the query identifies at least two versions of a known media content item. For example, the query module 220 may send a query of a query fingerprint representing a song 205 over the network 130 to reference fingerprint database 117 in order to identify various audio recordings (e.g., two or more versions of a single recording) associated with reference fingerprints that satisfy the query (e.g., match the query fingerprint based on certain match and/or comparison criteria). Further details regarding various query, comparison, and/or match techniques that may be utilized by the song identification system 140 will now be described.

As an example, suppose a moderate size fingerprint database includes 10,000 songs, with each song having an average duration of 5 minutes, which corresponds to approximately 250 million sub-fingerprints stored in the database (e.g., database 117). In order to match a fingerprint block of a query fingerprint to a fingerprint block of one or more reference fingerprints, the query module 210 compares the fingerprints until it locates one or more similar fingerprint blocks in the reference fingerprint database 117 (e.g., positions within in the 250 million sub-fingerprints where the bit error rate between fingerprints is minimal or below a threshold value). In order to search a database of such a size (e.g., 250 million sub-fingerprints or more) the search methods may only perform comparisons at certain candidate positions of the reference fingerprints, such as positions with a high probability of being a matching position within the database 117, among other techniques. For example, the query module 210 may only compare positions where one of the 256 sub-fingerprints of the fingerprint block query matches exactly. Of course, the query module 210 may utilize other techniques.

As another example, the query module 210 may utilize multiple types of query fingerprints when attempting to identify a media content item. The query module 210 may perform an initial lookup operation with a small fingerprint (e.g., a fingerprint associated with a first few seconds of a song) in order to reduce the scope of the search and identify a group of potential matching songs. For example, the query module 210 may perform an initial search using sub-fingerprints associated with the first 15 seconds of an unknown audio file, such as by utilizing Cantametrix fingerprint technology, in order to identify an initial candidate list of potential matching songs (e.g., reducing a query corpus approximately 3 orders of magnitude). The Cantametrix algorithm determines a list of songs that closely match based on a query of the first section of the songs.

The query module 210 may then perform comparisons of the entire query fingerprint (or, a reduced number of bits of the entire query fingerprint) to the reference fingerprints. For example, the query fingerprint may be 32 bits to represent the frequencies present in a given time slice, with a time slice=11 ms of the unknown audio recording, resulting in a fingerprint that is 40 kb for an audio recording having a duration of 4 minutes. As another example, frequency footprint of the fingerprint may be reduced to 8 bits, by examining every fourth frequency band of the audio file, resulting in a smaller fingerprint (e.g., a “nano” fingerprint) that is 16 times smaller. The query module 210 may then use the smaller nano fingerprint to query the reference fingerprint database 117 without undue time and resources costs, among other things.

As described herein, in some example embodiments, the query module 210 may perform the methods described herein and determine a match of an unknown media content item to two or more versions of a known media content item, such as a clean version and an explicit version of the known media content item. The versions may be identical, except in certain sections of a vocal track where swear words are removed or replaced in the vocal track. For example, an explicit version of a song may have a complete vocal track, whereas a clean version (or, radio edit) may have an incomplete vocal track where one or more words are changed, silenced, distorted, reversed, re-recorded, dubbed, or otherwise modified from the explicit version.

In some example embodiments, the difference comparison module 220 may access the reference fingerprints associated with the two or more versions of the known media content item, in order to identify which version is the correct version and matches the unknown media content item, such as song 205. The difference comparison module 220 may be configured and/or programmed to identify a portion of the known media content item where a first reference fingerprint associated with a first version of the known media content item differs from a second reference fingerprint associated with a second version of the known media content item.

In some example embodiments, the difference comparison module 220 may utilize an error comparison module 222 that is configured to compare the bit error rates between two or more versions of the known media content item. For example, the error comparison module 222 may be configured and/or programmed to calculate an average bit error rate between a query fingerprint and a reference fingerprint, identify an outlier bit error rate for the portion of the reference fingerprint by applying a median filter to the calculated average bit error rate, and determine the identified outlier bit error rate is above a threshold bit error rate associated with a difference between the versions of the known media content item that is associated with a word change between the versions of the known media content item.

For example, the error comparison module 222 may access a larger fingerprint of the song 205 (e.g., generated by fingerprint module 210), such as a 16 bit frequency footprint (e.g., a “micro” fingerprint), which may also be downsampled in time by 2, skipping every other audio frame, among other things. The error comparison module 222 may then perform a comparison between the micro fingerprint of song 205 and the reference fingerprints that represent the two or more versions of the known media content item, in order to discern a difference within a portion or frame of the version of the known media content item where a word in the lyrics has been modified.

In some cases, differences between two distinct versions of a known media content item may be minor, such that the reference fingerprints derived from the versions may both be considered as valid matches to a query fingerprint. Instead of returning both or all matches, the song identification system 140 may select the version associated with the reference fingerprint that best matches the query fingerprint (e.g., the fingerprint associated with a best matching distance calculation), and identify that version of the known media content item as the known content item.

In some cases, any comparison of fingerprint blocks leading to a bit error rate that is 2.75% or above the accumulated average bit error rate of the comparison indicates that a word, or something else, has been changed. The accumulated average may be a median filtered version of current bit error rate values, where the median filter ensures that a block containing changes does not skew the accumulated average bit error rate of the comparison.

Additionally, in some example embodiments, long term distortions introduced by audio codec encoding and decoding results in 2 or fewer bits being changed for a given 16 bit micro sub-fingerprint, whereas word changes (e.g., changes within a clean version) will often result is 3 or more bits being changed for a given 16 bit micro-sub fingerprint. Therefore, the error calculation module 222, in order to distinguish between valid word/version changes as opposed to differences due to codec distortion, may add bits to a bit error rate calculation where there is a difference of at least three bits between a query sub-fingerprint and a reference sub-fingerprint. In some example embodiments, the difference comparison module 220 may utilize a difference map module 224 that is configured to generate a difference map between two or more versions of the known media content item. For example, the difference map module 224 may be configured and/or programmed to generate a map that identifies the portion of the known media content item that includes a difference between the versions of the known media content item, select a second query fingerprint for the unknown media content item that includes a portion of the unknown media content item associated with the portion of the known media file identified by the generated map, and compare a portion of the second query fingerprint to the portion of the reference fingerprint that includes the difference between the versions of the known media content item.

The difference map module 224 may communicate a difference map, such as a mapping of differences between two versions of a song (e.g., the frames of each version that are different due to changed or removed words) to the client device 120. The query fingerprint generator 125 may then identify the frames that includes the differences, determine and/or derive a fingerprint for corresponding portions of the unknown media content item, and perform a comparison of the query fingerprint to the two or more versions of the known media content item using the query fingerprint that represents the portions of the unknown media content item that correspond to the differences between the versions of the known media content item.

In some example embodiments, the difference comparison module 220 may utilize a track comparison module 226 that is configured to compare one more discrete tracks (e.g., a vocal track) of the unknown media content item to one or more corresponding tracks of the two or more versions of the known media content item. For example, the track comparison module 226 may be configured and/or programmed to select a vocal query fingerprint for a vocal track of the unknown media content item, select vocal reference fingerprints for vocal tracks of the versions of the known media content item, and compare the vocal query fingerprint to the vocal reference fingerprints.

The track comparison module 226 may separate out a spatial center of the unknown file and the versions of the known media content items, determine fingerprints for the spatial centers of the media content items, and perform a comparison of the determined fingerprints. In some example embodiments, the track comparison module 226 may pre-process the unknown media content item and the versions of the known media content item at the client device 120 and reference library 110, respectively, in order to extract the center channel (e.g., the vocal track) of the media content items and determine fingerprints for the extracted center channels.

As an example, a large majority of all center channels include lead vocals, which generally are the track of an audio recording that include differences between clean and explicit versions. Thus, the track comparison module 226 may effectively compare the words between versions of an audio recording by performing a comparison of fingerprints representing the center channels of the versions of the audio recording.

Of course, the difference comparison module 220 may utilize other modules, components, and/or methods when comparing two distinct versions of a known media content item. For example, the difference comparison module 220 may identify differences between versions that are associated with speed-up factors, coding qualities, different fade-outs/ins, audio corruption like skips and drop-outs, and so on. In some example embodiments, the match module 230 is configured and/or programmed to match the at least one query fingerprint to a subset of the first reference fingerprint and a subset of the second reference fingerprint associated with the portion of the known media content item that differs between the first reference fingerprint and the second reference fingerprint, and identify the unknown media content item based on a match between the at least one query fingerprint and one of the first reference fingerprint and the second reference fingerprint.

In some example embodiments, the match module 230 may determine that one version of a known media content item is of a better quality than other versions of the known media content item, and match the unknown media content item to the better quality version. For example, the match module 230 may access information determined by the difference comparison module 220 and select a version to match to the unknown media content item based on the information indicating the selected version is a high quality version of the known media content item, and therefore a high quality and matching version of the unknown media content item.

As described herein, in some example embodiments, the song identification system 140 includes various components and/or modules configured to match an unknown media content item to a specific version of a known media content item. FIG. 3A is a flow diagram illustrating an example method 300 for identifying a correct version of a media content item, according to some example embodiments.

The method 300 may be performed by the song identification system 140 and, accordingly, is described herein merely by way of reference thereto. It will be appreciated that the method 300 may be performed on any suitable hardware.

In operation 310, the song identification system 140 queries, using at least one query fingerprint, a database of reference fingerprints associated with a plurality of known media content items, the at least one query fingerprint being derived from an unknown media content item. For example, the query module 210 performs a comparison of the query fingerprint to reference fingerprints located in the reference fingerprint database 117.

In operation 320, the song identification system 140 determines that a result of the query identifies at least two versions of a known media content item of the plurality of known media content items. For example, the query module 210 determines a result of the query identifies a list of candidate fingerprints, including candidate fingerprints associated with two or more versions of a single known media content item.

In operation 330, the song identification system 140 identifies a portion of the known media content item where a first reference fingerprint associated with a first version of the known media content item differs from a second reference fingerprint associated with a second version of the known media content item. For example, the query module 210 identifies at least two versions of a known media content item that include a clean version of the known media content item and an explicit version of the known media content item. For example, the query result may include metadata for the candidate reference fingerprints that identify the fingerprints as representing an explicit version and/or a clean version of a known audio recording.

In operation 340, the song identification system 140 matches the at least one query fingerprint to a subset of the first reference fingerprint and a subset of the second reference fingerprint associated with the portion of the known media content item that differs between the first reference fingerprint and the second reference fingerprint. For example, the difference comparison module 220 identifies differences between versions of a known media content item, and compares the query fingerprint to portions of reference fingerprints associated with the portions of the versions of the known media content item associated with the identified differences.

In some example embodiments, the song identification system 140 (e.g., the difference comparison module 220), may remove or not include fingerprint match errors based on data compression or other non-substantive or non-content based distortions. FIG. 3B is a flow diagram illustrating an example method 360 for matching a query fingerprint to a reference fingerprint, according to some example embodiments. The method 360 may be performed by the difference comparison module 220 and, accordingly, is described herein merely by way of reference thereto. It will be appreciated that the method 360 may be performed on any suitable hardware.

In operation 370, the difference comparison module 220 identifies non-matching bits between a query fingerprint and a reference fingerprint. For example, the difference comparison module 220 may identify bits that don't match based on data compression errors associated with an unknown content item and/or a known content item, or other distortions.

In operation 380, the difference comparison module 220 calculates a baseline statistic for the identified non-matching bits. For example, the difference comparison module 220 may normalize or otherwise remove distortion-based errors that cause corresponding bits to not match during a comparison of fingerprints.

In operation 390, the difference comparison module 220 matches the query fingerprint to the reference fingerprint using bits not included in the baseline statistic. For example, the difference comparison module 220 may only consider bits not included in a baseline statistic associated with data compression and other distortion errors.

Thus, the difference comparison module 220 may identify differences between the first reference fingerprint and the second reference fingerprint that are based on differences in content between the first version and the second version of the known media content item, and not based on data compression errors or other distortions of the media content item, among other things.

Referring back to FIG. 3A, in operation 350, the song identification system 140 identifies the unknown media content item based on a match between the at least one query fingerprint and one of the first reference fingerprint and the second reference fingerprint. For example, the match module 230 compares the query fingerprint, or aspects of the query fingerprint (e.g., a block of sub-fingerprints), to reference fingerprints representative of the versions of the known media content item, in order to match the unknown media content item to one of the versions of the known media content item. The match module 230 may perform a variety of different fingerprint query and/or matching techniques, such as those described herein.

As described herein, in some example embodiments, the song identification system 140 may perform different methods and/or techniques when determined which version of a known media content item matches an unknown media content item, such as methods depicted in FIGS. 4-6.

FIG. 4 is a flow diagram illustrating an example method 400 for identifying a correct version of a known media content item based on error rate calculations (e.g., bit error rate calculations), according to some example embodiments. The method 400 may be performed by the song identification system 140 and, accordingly, is described herein merely by way of reference thereto. It will be appreciated that the method 400 may be performed on any suitable hardware.

In operation 410, the error comparison module 222 calculates an average bit error rate between a portion of the query fingerprint and the reference fingerprint. In operation 420, the error comparison module 222 identifies an outlier bit error rate for the portion of the reference fingerprint by applying a median filter to the calculated average bit error rate. In operation 430, the error comparison module 222 determines the identified outlier bit error rate is above a threshold bit error rate associated with a difference between the version of the known media content item that is associated with a word change between the versions of the known media content item.

For example, the error comparison module 222 may identify an outlier bit error rate that is 3 or more bits for a 16 bit sub-fingerprint, and determine that the identified bit rate is above a threshold bit rate associated with differences in words between two media content items.

In some example embodiments, the error comparison module 222 may compare other errors associated with media content items, such as compression errors, distortion errors, and other errors described herein that may contribute to differences during comparisons of fingerprints derived from media content items.

FIG. 5 is a flow diagram illustrating an example method 500 for identifying a correct version of a known media content item based on a difference map between versions of a known media content item, according to some example embodiments. The method 500 may be performed by the song identification system 140 and, accordingly, is described herein merely by way of reference thereto. It will be appreciated that the method 500 may be performed on any suitable hardware.

In operation 510, the difference map module 224 generates a map that identifies the section of the known media content item that includes a difference between the versions of the known media content item. In operation 520, the difference map module 224 selects a second query fingerprint for the unknown media content item that includes a section of the unknown media content item associated with the section of the known media content item identified by the generated map. In operation 530, the difference map module 224 compares a portion of the second query fingerprint to the portion of the reference fingerprint that includes the difference between the versions of the known media content item.

For example, the difference map module 224 may identify one or more frames that are different between two versions of a known media content item, and compare a portion of a query fingerprint associated with the one or more frames to the portions of the reference fingerprints representing the one or more frames in order to determine which version of the known media content item matches the unknown media content item.

In some example embodiments, the song identification system 140 may utilize a difference map to instruct the reference fingerprint generator 115 to determine a reference fingerprint for the identified portions of the known media item that are associated with differences between versions. For example, the difference map module 224 may generate the map, and transmit the map to the reference query fingerprint generator 115, for use in determining a reference fingerprint. The song identification system 140 may select and/or otherwise access the determined reference fingerprint (based on the difference map) for use in comparing versions of the known media item to the unknown media item via fingerprint matching.

FIG. 6 is a flow diagram illustrating an example method for identifying a correct version of a known media content item based on a comparison of a source separated track that extracts the vocal, according to some example embodiments. The method 600 may be performed by the song identification system 140 and, accordingly, is described herein merely by way of reference thereto. It will be appreciated that the method 600 may be performed on any suitable hardware.

In operation 610, the track comparison module 226 selects a vocal query fingerprint for a source separated track that extracts the vocal of the unknown media content item. In operation 620, the track comparison module 226 selects vocal reference fingerprints for a source separated track that extracts the vocal of the versions of the known media content item. In operation 630, the track comparison module 226 compares the source separated query fingerprint to the source separated reference fingerprints.

For example, the track comparison module 226 may select a source separated vocal query fingerprint from a center channel of an unknown audio recording and select source separated vocal reference fingerprints for the center channels of the two or more versions of the known audio recording. The track comparison module 226 may then compare the fingerprints in order to determine which version of the known audio recording matches the unknown audio recording.

In some example embodiments, the song identification system 140 compares a query fingerprint to reference fingerprints representing multiple versions of a known media content item and determines one of the versions of the known media content item match the unknown media content item based on a quality of the comparison. FIG. 7 is a flow diagram illustrating an example method 700 for comparing an unknown media content item to two or more versions of a known media content item, according to some example embodiments. The method 700 may be performed by the song identification system 140 and, accordingly, is described herein merely by way of reference thereto. It will be appreciated that the method 700 may be performed on any suitable hardware.

In operation 710, the song identification system 140 accesses an unknown media content item. For example, the query module 210 accesses a query fingerprint derived from an unknown media content item.

In operation 720, the song identification system 140 queries a database of reference fingerprints associated with known media content items with the query fingerprint. For example, the query module 210 performs a comparison of the query fingerprint to reference fingerprints located in the reference fingerprint database 117.

In operation 730, the song identification system 140 determines that a result of the query identifies at least two versions of a known media content item. For example, the query module 210 receives a result of the query that identifies a list of candidate fingerprints, including candidate fingerprints associated with two or more versions of a single known media content item.

In some example embodiments, the query module 210 identifies at least two versions of a known audio recording that include a clean version of the known audio recording and an explicit version of the known audio recording. For example, the results may include metadata for the candidate reference fingerprints that identify the fingerprints as representing an explicit version and/or a clean version of a known audio recording.

In operation 740, the song identification system 140 calculates a match score for each of the at least two versions of the known media content item. For example, the match module 230 may calculate a match score to be assigned to each of the versions of the known media content item. The match score may indicate, for example, a quality of match between an unknown media content item and a version of an known media content item, a magnitude of differences between the unknown media content item and the version of the known media content item, and so on.

In operation 750, the song identification system 140 determines the unknown media content item is a version of the known media content item having the highest match score. For example, the match module 230 determines the version of the known media content item assigned the highest match score is the version that matches the unknown media content item.

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system and within which instructions 824 (e.g., software) for causing the machine 800 to perform any one or more of the methodologies discussed herein may be executed. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, an STB, a PDA, a cellular telephone, a smartphone, a web appliance, a network router, a network switch, a network bridge, or any machine capable of executing the instructions 824 (sequentially or otherwise) that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a graphics display 810 (e.g., a plasma display panel (PDP), an LED display, an LCD, a projector, or a CRT). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), and a network interface device 820.

The storage unit 816 includes a machine-readable medium 822 on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 (e.g., network 130) via the network interface device 820.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., software) for execution by the machine (e.g., machine 800), such that the instructions, when executed by one or more processors of the machine (e.g., processor 802), cause the machine to perform any one or more of the methodologies described herein. The term “machine-readable medium” shall accordingly be taken to include, but not be limited to, a data repository in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method, comprising:
querying, using at least one query fingerprint, a database of reference fingerprints associated with a plurality of known media content items, the at least one query fingerprint being derived from an unknown media content item;
determining that a result of the query identifies at least two versions of a known media content item of the plurality of known media content items;
identifying a portion of the known media content item where a first reference fingerprint associated with a first version of the known media content item differs from a second reference fingerprint associated with a second version of the known media content item;
matching at least one query fingerprint to the first reference fingerprint and the second reference fingerprint based on the identified portion of the known media content item that differs between the first reference fingerprint and the second reference fingerprint; and
identifying the unknown media content item based on a match between the at least one query fingerprint and one of the first reference fingerprint and the second reference fingerprint.

2. The method of claim 1, wherein determining that a result of the query identifies at least two versions of a known audio content item includes determining that the result of the query identifies a clean version of a known audio content item and an explicit version of the known audio content item.

3. The method of claim 1, wherein identifying a portion of the known media content item where a first reference fingerprint associated with a first version of the known media content item differs from a second reference fingerprint associated with a second version of the known media content item includes:
calculating an average bit error rate between at least one query fingerprint and the reference fingerprints; and
identifying an outlier bit error rate for the reference fingerprints by applying a median filter to the calculated average bit error rate; and
determining the identified outlier bit error rate is above a threshold bit error rate associated with a difference between the versions of the known media content item that is associated with a word change between the versions of the known media content item.

4. The method of claim 1, wherein matching at least one query fingerprint to the first reference fingerprint and the second reference fingerprint based on the identified portion of the known media content item that differs between the first reference fingerprint and the second reference fingerprint includes:
generating a map that identifies the portion of the known media content item that includes a difference between the versions of the known media content item;
selecting a second query fingerprint for the unknown media content item that includes a portion of the unknown media content item associated with the portion of the known media file identified by the generated map; and
comparing a portion of the second query fingerprint to the portion of the reference fingerprint that includes the difference between the versions of the known media content item.

5. The method of claim 1, wherein matching at least one query fingerprint to the first reference fingerprint and the second reference fingerprint based on the identified portion of the known media content item that differs between the first reference fingerprint and the second reference fingerprint includes:
selecting a source separated vocal query fingerprint associated with a vocal track of the unknown media content item;
selecting a source separated vocal reference fingerprint associated with vocal tracks of the versions of the known media content item; and
comparing the source separated vocal query fingerprint to the source separated vocal reference fingerprints.

6. The method of claim 1, wherein identifying a portion of the known media content item where a first reference fingerprint associated with a first version of the known media content item differs from a second reference fingerprint associated with a second version of the known media content item includes identifying a portion of the known media content item that includes a source separated vocal track.

7. The method of claim 1, wherein determining that a result of the query identifies at least two versions of a known media content item includes determining that at least one of the two versions of the known media content item is associated with metadata identifying the version as an explicit version or a clean version of the known media content item.

8. The method of claim 1, wherein determining that a result of the query identifies at least two versions of a known media content item includes determining that at least one of the two versions of the known media content item is associated with metadata identifying the version as one of multiple versions of the known media content item.

9. The method of claim 1, wherein the unknown media content item is an audio recording.

10. A computer-readable storage medium whose contents, when executed by a computing system, cause the computing system to perform operations, comprising:
accessing a query fingerprint derived from an unknown media content item;
querying, with the query fingerprint, a database of reference fingerprints associated with known media content items;
determining that a result of the query identifies at least two versions of a known media content item;
calculating a match score for each of the at least two versions of the known media content item; and
determining the unknown media content item is a version of the known media content item having the highest match score.

11. The computer-readable storage medium of claim 10, wherein calculating a match score for each of the at least two versions of the known media content item includes calculating a match score that is associated with a bit error rate calculated for a comparison of the query fingerprint and the reference fingerprints.

12. The computer-readable storage medium of claim 10, wherein calculating a match score for each of the at least two versions of the known media content item includes:
identifying a section that includes a difference between the versions of the known media content item;
comparing a portion of the query fingerprint to portions of the reference fingerprint that include the difference between the versions of the known media content item; and
calculating the match score for each of the versions of the known media content item based on the comparison.

13. A system, comprising:
a query module configured to:
query, using at least one query fingerprint, a database of reference fingerprints associated with a plurality of known media content items, the at least one query fingerprint being derived from an unknown media content item; and
determine that a result of the query identifies at least two versions of a known media content item of the plurality of known media content items;
a difference comparison module configured to identify a portion of the known media content item where a first reference fingerprint associated with a first version of the known media content item differs from a second reference fingerprint associated with a second version of the known media content item; and
a match module configured to:
match at least one query fingerprint to the first reference fingerprint and the second reference fingerprint based on the identified portion of the known media content item that differs between the first reference fingerprint and the second reference fingerprint; and
identify the unknown media content item based on a match between the at least one query fingerprint and one of the first reference fingerprint and the second reference fingerprint.

14. The system of claim 13, wherein the query module is configured to determine that the result of the query identifies a clean version of a known audio content item and an explicit version of the known audio content item.

15. The method of claim 13, wherein the difference comparison module is configured to:
calculate an average bit error rate between the at least one query fingerprint and the reference fingerprints; and
identify an outlier bit error rate for the reference fingerprints by applying a median filter to the calculated average bit error rate; and
determine the identified outlier bit error rate is above a threshold bit error rate associated with a difference between the versions of the known media content item that is associated with a word change between the versions of the known media content item.

16. The system of claim 13, wherein the difference comparison module is configured to:
generate a map that identifies the portion of the known media content item that includes a difference between the versions of the known media content item;
select a second query fingerprint for the unknown media content item that includes a portion of the unknown media content item associated with the portion of the known media file identified by the generated map; and
compare a portion of the second query fingerprint to the portion of the reference fingerprint that includes the difference between the versions of the known media content item.

17. The system of claim 13, wherein the difference comparison module is configured to identify a portion of the known media content item that includes a source separated vocal track.

18. The system of claim 13, wherein the query module is configured to determine that at least one of the at least two versions of the known media content item is associated with metadata identifying the version as an explicit version or a clean version of the known media content item.

19. The system of claim 13, wherein the query module is configured to determine that at least one of the at least two versions of the known media content item is associated with metadata identifying the version as one of multiple versions of the known media content item.

20. The system of claim 13, wherein the difference comparison module is configured to identify differences between the first reference fingerprint and the second reference fingerprint that are based on differences in content between the first version and the second version of the known media content item.
